(19) United States
(12) Patent Application Publication
(10) Pub. No.: US 2025/0052244 A1
(43) Pub. Date: Feb. 13, 2025

(54) Compressor Having Shutdown Valve Assembly

(71) Applicant: Copeland LP, Sidney, OH (US)

(72) Inventors: Yogesh S. MAHURE, Pune (IN); Nikhil NAIK, Pune (IN); Mohak BEHL, Pune (IN)

(73) Assignee: Copeland LP, Sidney, OH (US)

(21) Appl. No.: 18/753,630

(22) Filed: Jun. 25, 2024

(30) Foreign Application Priority Data
Aug. 8, 2023 (IN) 202321053150

(51) Int. Cl. F04C 29/12; F04C 18/02

(52) U.S. Cl. CPC F04C 29/124; F04C 18/0215; F04C 29/126

(57) ABSTRACT

A compressor may a first scroll, a second scroll, and a valve assembly. The second scroll may include a discharge passage. The valve assembly may include a valve housing fixed relative to the second scroll and a valve member movably received in the valve housing. The valve housing may include a plurality of angled apertures that are angled relative to a direction in which the valve member moves between the open and closed positions. The valve member is movable relative to the valve housing and valve retainer between an open position and a closed position. When the valve member is in the open position, fluid is allowed to flow through the discharge passage and the angled apertures in the valve housing. When the valve member is in the closed position, fluid flow through the discharge passage and the angled apertures is restricted.

### CROSS-REFERENCE TO RELATED APPLICATIONS

This application claims the benefit and priority of Indian Patent Application No. 202321053150, filed Aug. 8, 2023. The entire disclosure of the above application is incorporated herein by reference.

### FIELD

The present disclosure relates to a compressor having a shutdown valve assembly.

### BACKGROUND

This section provides background information related to the present disclosure and is not necessarily prior art.

A climate-control system such as, for example, a heat-pump system, a refrigeration system, or an air conditioning system, may include a fluid circuit having an outdoor heat exchanger, an indoor heat exchanger, an expansion device disposed between the indoor and outdoor heat exchangers, and one or more compressors circulating a working fluid (e.g., a refrigerant) between the indoor and outdoor heat exchangers. Efficient and reliable operation of the one or more compressors is desirable to ensure that the climate-control system in which the one or more compressors are installed is capable of effectively and efficiently providing a cooling and/or heating effect on demand.

### SUMMARY

This section provides a general summary of the disclosure and is not a comprehensive disclosure of its full scope or all of its features.

In one aspect, the present disclosure provides a compressor that includes a first scroll, a second scroll, and a valve assembly (e.g., a shutdown valve assembly). The first scroll includes a first end plate and a first spiral wrap extending from the first end plate. The second scroll includes a second end plate and a second spiral wrap extending from the second end plate and meshing with the first spiral wrap to define fluid pockets therebetween. The second end plate may include a discharge passage and a discharge recess. The valve assembly may be disposed at least partially within the discharge recess and may include a valve housing, a valve retainer, and valve member. The valve housing may be fixed relative to the second scroll. The valve retainer may be fixed relative to the valve housing. The valve member may be movably received in the valve housing. The valve member is movable relative to the valve housing and valve retainer between an open position and a closed position. When the valve member is in the open position, fluid is allowed to flow through the discharge passage and the valve assembly. When the valve member is in the closed position, fluid flow through the discharge passage and the valve assembly is restricted. The valve housing may include a plurality of angled apertures that are angled relative to a direction in which the valve member moves between the open and closed positions.

In some configurations of the compressor of the above paragraph, the angled apertures in the valve housing extend between an inner diametrical surface of the valve housing and an outer diametrical surface of the valve housing.

In some configurations of the compressor of either or both of the above paragraphs, the openings of the angled apertures at the inner diametrical surface of the valve housing are disposed between the valve member and the discharge passage when the valve member is in the open position.

In some configurations of the compressor of any one or more of the above paragraphs, a radially outer surface of the valve member covers the openings of the angled apertures when the valve member is in the closed position.

In some configurations of the compressor of any one or more of the above paragraphs, the radially outer surface of the valve member slidingly contacts the inner diametrical surface of the valve housing as the valve member moves between the open and closed positions.

In some configurations of the compressor of any one or more of the above paragraphs, the valve housing includes a gas-return aperture.

In some configurations of the compressor of any one or more of the above paragraphs, the gas-return aperture and the angled apertures are in fluid communication with a discharge-pressure region (e.g., a discharge chamber) of the compressor.

In some configurations of the compressor of any one or more of the above paragraphs, the valve housing includes a projection that extends into an interior volume of the valve housing and includes an axial end surface that defines a stop for the valve member in the open position.

In some configurations of the compressor of any one or more of the above paragraphs, the gas-return aperture extends through the axial end surface of the projection.

In some configurations of the compressor of any one or more of the above paragraphs, the valve retainer defines a valve seat that contacts the valve member when the valve member is in the closed position.

In some configurations of the compressor of any one or more of the above paragraphs, the valve seat defines an opening that is in fluid communication with the discharge passage.

In some configurations of the compressor of any one or more of the above paragraphs, the valve housing includes a base portion and a body portion.

In some configurations of the compressor of any one or more of the above paragraphs, the base portion has a larger diameter than the body portion and fixedly engages an inner diametrical surface of a hub of the second scroll.

In some configurations of the compressor of any one or more of the above paragraphs, the angled apertures are disposed in the body portion.

In some configurations of the compressor of any one or more of the above paragraphs, the body portion and the inner diametrical surface of the hub cooperate to define an annular gas flow path that is in fluid communication with the angled apertures and the discharge passage when the valve member is in the open position.

In another aspect, the present disclosure provides a compressor that includes a first scroll, a second scroll, and a valve assembly (e.g., a shutdown valve assembly). The first scroll includes a first end plate and a first spiral wrap extending from the first end plate. The second scroll includes a second end plate and a second spiral wrap extending from the second end plate and meshing with the first spiral wrap to define fluid pockets therebetween. The second end plate may include a discharge passage. The valve assembly may include a valve housing fixed relative to the second scroll, a valve retainer fixed relative to the valve housing, and a valve member movably received in the valve housing. The valve housing may include a plurality of angled apertures that are angled relative to a direction in which the valve member moves between the open and closed positions. The valve member is movable relative to the valve housing and valve retainer between an open position and a closed position. When the valve member is in the open position, fluid is allowed to flow through the discharge passage and through the angled apertures in the valve housing. When the valve member is in the closed position, fluid flow through the discharge passage and the angled apertures is restricted.

In some configurations of the compressor of the above paragraph, the angled apertures in the valve housing extend between an inner diametrical surface of the valve housing and an outer diametrical surface of the valve housing.

In some configurations of the compressor of either or both of the above paragraphs, the openings of the angled apertures at the inner diametrical surface of the valve housing are disposed between the valve member and the discharge passage when the valve member is in the open position.

In some configurations of the compressor of any one or more of the above paragraphs, a radially outer surface of the valve member covers the openings of the angled apertures when the valve member is in the closed position.

In some configurations of the compressor of any one or more of the above paragraphs, the radially outer surface of the valve member slidingly contacts the inner diametrical surface of the valve housing as the valve member moves between the open and closed positions.

In some configurations of the compressor of any one or more of the above paragraphs, the valve housing includes a gas-return aperture.

In some configurations of the compressor of any one or more of the above paragraphs, the gas-return aperture and the angled apertures are in fluid communication with a discharge-pressure region (e.g., a discharge chamber) of the compressor.

In some configurations of the compressor of any one or more of the above paragraphs, the valve housing includes a projection that extends into an interior volume of the valve housing and includes an axial end surface that defines a stop for the valve member in the open position.

In some configurations of the compressor of any one or more of the above paragraphs, the gas-return aperture extends through the axial end surface of the projection.

In some configurations of the compressor of any one or more of the above paragraphs, the valve retainer defines a valve seat that contacts the valve member when the valve member is in the closed position.

In some configurations of the compressor of any one or more of the above paragraphs, the valve seat defines an opening that is in fluid communication with the discharge passage.

In some configurations of the compressor of any one or more of the above paragraphs, the valve housing includes a base portion and a body portion.

In some configurations of the compressor of any one or more of the above paragraphs, the base portion has a larger diameter than the body portion and fixedly engages an inner diametrical surface of a hub of the second scroll.

In some configurations of the compressor of any one or more of the above paragraphs, the angled apertures are disposed in the body portion.

In some configurations of the compressor of any one or more of the above paragraphs, the body portion and the inner diametrical surface of the hub cooperate to define an annular gas flow path that is in fluid communication with the angled apertures and the discharge passage when the valve member is in the open position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a cross-sectional view of a compressor having a shutdown valve assembly according to the principles of the present disclosure;

FIG. 2 is a cross-sectional view of a scroll and the shutdown valve assembly of the compressor of FIG. 1 with the shutdown valve assembly in a closed position;

FIG. 3 is a cross-sectional view of the scroll and the shutdown valve assembly of the compressor of FIG. 1 with the shutdown valve assembly in an open position;

FIG. 4 is an exploded view of the shutdown valve assembly of FIGS. 1-3;

FIG. 5 is a cross-sectional view of the scroll and another shutdown valve assembly in a closed position;

FIG. 6 is a cross-sectional view of the scroll and the shutdown valve assembly of FIG. 5 in an open position;

FIG. 7 is a perspective view of the shutdown valve assembly of FIGS. 5 and 6;

FIG. 8 is an exploded view of the shutdown valve assembly of FIGS. 5-7;

FIG. 9 is a cross-sectional view of the scroll and yet another shutdown valve assembly in a closed position;

FIG. 10 is a cross-sectional view of the scroll and the shutdown valve assembly of FIG. 9 in an open position;

FIG. 11 is an exploded view of the shutdown valve assembly of FIGS. 9 and 10;

FIG. 12 is a perspective view of a valve housing of the shutdown valve assembly of FIGS. 9-11;

FIG. 13 is a cross-sectional view of the scroll and still another shutdown valve assembly in a closed position;

FIG. 14 is a cross-sectional view of the scroll and the shutdown valve assembly of FIG. 13 in an open position;

FIG. 15 is a perspective view of the shutdown valve assembly of FIGS. 13 and 14;

FIG. 16 is an exploded view of the shutdown valve assembly of FIGS. 13-15; and

FIG. 17 is a perspective view of a valve housing of the shutdown valve assembly of FIGS. 13-16.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

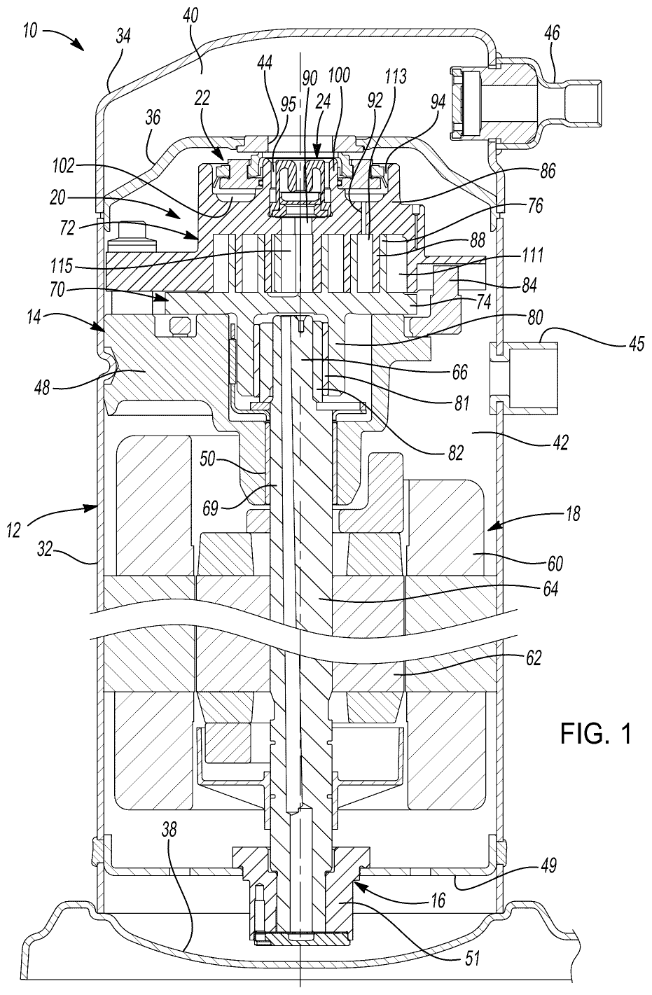

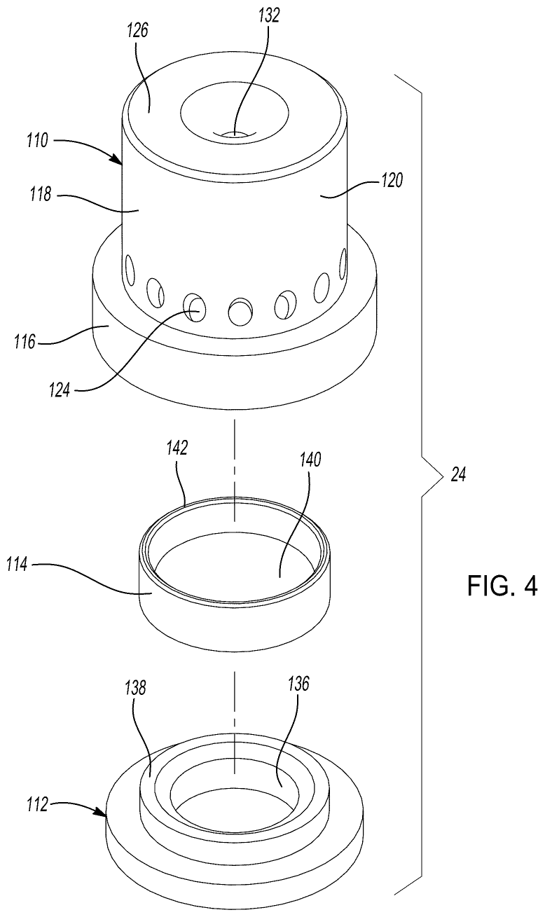

With reference to FIGS. 1-4, a compressor 10 is provided that may include a hermetic shell assembly 12, first and second bearing-housing assemblies 14, 16, a motor assembly 18, a compression mechanism 20, a floating seal assembly 22, and a shutdown valve assembly 24.

The shell assembly 12 may form a compressor housing and may include a cylindrical shell 32, an end cap 34 at an upper end thereof, a transversely extending partition 36, and a base 38 at a lower end thereof. The end cap 34 and the partition 36 may define a discharge chamber 40. The partition 36 may separate the discharge chamber 40 from a suction chamber 42. A discharge passage 44 may extend through the partition 36 to provide communication between the compression mechanism 20 and the discharge chamber 40. A suction fitting 45 may provide fluid communication between the suction chamber 42 and a low side of a climate-control system in which the compressor 10 is installed. A discharge fitting 46 may provide fluid communication between the discharge chamber 40 and a high side of the climate-control system in which the compressor 10 is installed.

The first bearing-housing assembly 14 may be fixed relative to the shell 32 and may include a first bearing-housing 48 and a first bearing 50. The first bearing-housing 48 may axially support the compression mechanism 20 and may house the first bearing 50 therein. The first bearing-housing 48 may include a plurality of radially extending arms engaging the shell 32. The second bearing-housing assembly 16 may be fixed relative to the shell 32 and may include a second bearing-housing 49 and a second bearing 51.

The motor assembly 18 may include a motor stator 60, a rotor 62, and a driveshaft 64. The motor stator 60 may be press fit into the shell 32. The rotor 62 may be press fit on the driveshaft 64 and may transmit rotational power to the driveshaft 64. The driveshaft 64 may be rotatably supported by the first and second bearing-housing assemblies 14, 16. The driveshaft 64 may include an eccentric crank pin 66 having a flat surface thereon. A main body 69 of the driveshaft 64 may be rotatably supported by the first and second bearings 50, 51 and the first and second bearing-housing assemblies 48, 49.

The compression mechanism 20 may include an orbiting scroll 70 and a non-orbiting scroll 72. The orbiting scroll 70 may include an end plate 74 and a spiral wrap 76 extending therefrom. A cylindrical hub 80 may project downwardly from the end plate 74 and may include a drive bushing 82 disposed therein. A drive bearing 81 may also be disposed within the hub 80 and may surround the drive bushing 82 and the crank pin 66 (i.e., the drive bearing 81 may be disposed radially between the hub 80 and the drive bushing 82). The drive bushing 82 may include an inner bore in which the crank pin 66 is drivingly disposed. The crank pin flat may drivingly engage a flat surface in a portion of the inner bore to provide a radially compliant driving arrangement. An Oldham coupling 84 may be engaged with the orbiting scroll 70 and the first bearing housing 48 to prevent relative rotation between the orbiting and non-orbiting scrolls 70, 72. Alternatively, the Oldham coupling 84 may be engaged with the orbiting and non-orbiting scrolls 70, 72 to prevent relative rotation between the orbiting and non-orbiting scrolls 70, 72.

The non-orbiting scroll 72 may include an end plate 86 and a spiral wrap 88 projecting downwardly from the end plate 86. The spiral wrap 88 may meshingly engage the spiral wrap 76 of the orbiting scroll 70, thereby creating a series of moving fluid pockets (i.e., compression pockets). The fluid pockets defined by the spiral wraps 76, 88 may decrease in volume as they move from a radially outer position 111 (at a suction pressure) to a radially intermediate position 113 (at an intermediate pressure) to a radially inner position 115 (at a discharge pressure) throughout a compression cycle of the compression mechanism 20.

The end plate 86 may include a discharge passage 90, an intermediate-pressure passage (or biasing passage) 92, an annular recess 94, and a discharge recess 95. The discharge passage 90 is in communication with one of the fluid pockets at the radially inner position 115 and allows compressed working fluid (at the discharge pressure) to flow through the discharge passage 44 in the partition 36 and into the discharge chamber 40. The shutdown valve assembly 24 may be disposed within the discharge recess 95 to allow fluid flow from the fluid pocket at the radially inner position 115 to the discharge chamber 40 and prevent or restrict fluid flow from the discharge chamber 40 to the fluid pocket at the radially inner position 115.

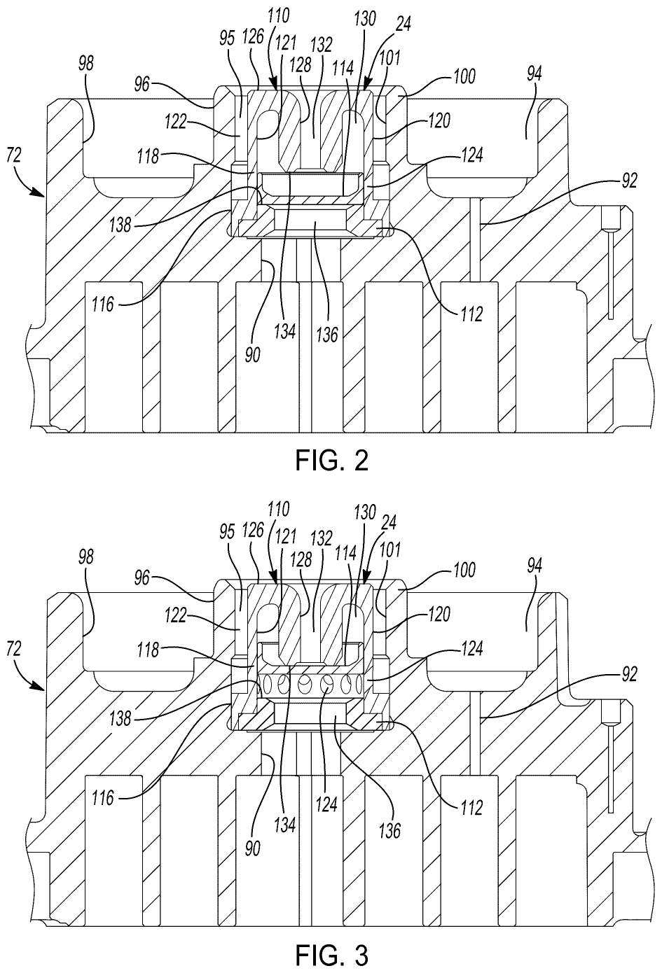

The intermediate-pressure passage 92 may provide communication between one of the fluid pockets at the radially intermediate position 113 and the annular recess 94. The annular recess 94 may surround (i.e., encircle) the discharge recess 95. As shown in FIGS. 2 and 3, the annular recess 94 may include a first diametrical surface 96 and a second diametrical surface 98. The first diametrical surface 96 surrounds the discharge recess 95, and the second diametrical surface 98 surrounds the first diametrical surface 96 and the discharge recess 95 (i.e., the second diametrical surface 98 is disposed radially outward relative to the first diametrical surface 96). The end plate 86 may include an annular hub 100 that defines the annular recess 94 and the discharge recess 95. That is, the first diametrical surface 96 is an outer diametrical surface of the annular hub 100, and the discharge recess 95 defines an inner diametrical surface 101 of the annular hub 100. The discharge recess 95 extends through the annular hub 100 and is in communication with the discharge passage 90.

The annular recess 94 may at least partially receive the floating seal assembly 22 and may cooperate with the floating seal assembly 22 to define an annular biasing chamber 102 (FIG. 1) therebetween. The floating seal assembly 22 sealingly engages the first and second diametrical surfaces 96, 98 and the partition 36. In this manner, the floating seal assembly 22 fluidly separates the biasing chamber 102 from the suction chamber 42 and the discharge chamber 40 and fluidly separates the suction chamber 42 from the discharge chamber 40.

The biasing chamber 102 receives intermediate-pressure fluid (e.g., fluid at a pressure less than discharge pressure and higher than suction pressure) from the fluid pocket in the intermediate position 113 through the intermediate-pressure passage 92. A pressure differential between the intermediate-pressure fluid in the biasing chamber 102 and fluid in the suction chamber 42 exerts a net axial biasing force on the non-orbiting scroll 72 urging the non-orbiting scroll 72 toward the orbiting scroll 70 in an axial direction (i.e., in a direction along or parallel to the rotational axis of the driveshaft 64). In this manner, the tips of the spiral wrap 88 of the non-orbiting scroll 72 are urged into sealing engagement with the end plate 74 of the orbiting scroll 70 and the end plate 86 of the non-orbiting scroll 72 is urged into sealing engagement with the tips of the spiral wrap 76 of the orbiting scroll 70.

As shown in FIGS. 2-4, the shutdown valve assembly 24 may include a valve housing 110, a retainer 112, and a valve member 114. The valve member 114 is movable relative to the valve housing 110 and the retainer 112 between a closed position (FIG. 2) and an open position (FIG. 3). When the valve member 114 is in the open position, working fluid is allowed to flow through the shutdown valve assembly 24 between the discharge passage 90 and the discharge chamber 40. When the valve member 114 is in the closed position, working fluid is restricted or prevent from flowing through the shutdown valve assembly 24 thereby restricting or preventing fluid flow between the discharge passage 90 and the discharge chamber 40. Pressure differentials between the discharge passage 90 and the discharge chamber 40 move the valve member 114 between the open and closed positions.

The valve housing 110 may be a cylindrical cup-shaped member and may include a base portion 116 and a body portion 118. The base portion 116 may define a first diameter and may fixedly engage (e.g., via threaded engagement, press fit, and/or other means) the inner diametrical surface 101 of the hub 100. The body portion 118 may extend axially upward from an axial end of the base portion 116. The body portion 118 may define a second diameter that is smaller than the first diameter of the base portion 116 such that a radially outermost diametrical surface 120 of the body portion 118 is radially spaced apart from the inner diametrical surface 101 of the hub 100. In this manner, the body portion 118 and the hub 100 define an annular gas flow path 122 disposed radially between the inner diametrical surface 101 of the hub 100 and the outermost diametrical surface 120 of the body portion 118.

The valve housing 110 also includes a plurality of apertures 124 that extend generally radially through body portion 118 to provide fluid communication between the discharge passage 90 and the annular gas flow path 122. The apertures 124 may be angled. For example, a longitudinal axis of each aperture 124 may be disposed at a non-parallel and non-perpendicular angle (e.g., a 45-degree angle, for example) relative to the rotational axis of the driveshaft 64 and relative to a direction in which the valve member 114 moves between the open and closed positions. The apertures 124 may extend through the inner diametrical surface 121 and the outermost diametrical surface 120 of the body portion 118 of the valve housing 110. As shown in FIG. 2, the valve member 114 blocks the apertures 124 of the valve housing 110 when the valve member 114 is in the closed position to prevent fluid communication between the discharge passage 90 and the annular gas flow path 122. As shown in FIG. 3, when the valve member 114 is in the open position, the valve member 114 uncovers the apertures 124 (i.e., the apertures 124 are disposed between the valve member 114 and the discharge passage 90) to allow fluid communication between the discharge passage 90 and the annular gas flow path 122.

An axial end face 126 of the body portion 118 of the valve housing 110 extends radially inward relative to the radially outermost diametrical surface 120 and an inner diametrical surface 121 of the body portion 118. The axial end face 126 is disposed at the opposite axial end of the body portion 118 as the base portion 116 of the valve housing 110. A projection 128 extends from the axial end face 126 in an axial direction into an interior volume 130 of the valve housing 110 (i.e., the interior volume 130 defined by the inner diametrical surface 121). That is, the projection 128 extends from the axial end face 126 toward the discharge passage 90. The projection 128 shown in the figures is cylindrical, but it will be appreciated that the projection 128 could have any other suitable shape such as frustoconical or rectangular prism, for example. A gas-return aperture 132 may extend through the projection 128 and the axial end face 126. An axial end surface 134 of the projection 128 (i.e., the axial end of the projection 128 opposite the axial end face 126) may provide a hard stop for the valve member 114. That is, the axial end surface 134 contacts the valve member 114 in the open position (FIG. 3).

The retainer 112 may be fixed relative to the valve housing 110 and may extend into the interior volume 130 of the valve housing 110. The retainer 112 may be an annular member and includes an opening 136 that provides fluid communication between the discharge passage 90 and the interior volume 130 of the valve housing 110. The retainer 112 may define an annular valve seat 138 that contacts the valve member 114 in the closed position (as shown in FIG. 2). When the valve member 114 is in the open position (FIG. 3), the valve member 114 is spaced apart from the valve seat 138 so that fluid can flow from the discharge passage 90 through the opening 136, through the apertures 124, through the annular gas flow path 122, and into the discharge chamber 40. As shown in FIG. 3, the apertures 124 are disposed axially between the valve seat 138 and the axial end surface 134 of the projection 128, such that the apertures 124 are disposed axially between the valve seat 138 and the valve member 114 when the valve member 114 is in the open position.

The valve member 114 shown in the figures is generally cup-shaped and has a U-shaped cross section. The valve member 114 may include a disc-shaped main body 140 and an annular collar 142 extending axially from the main body 140. One side of the main body 140 contacts the axial end surface 134 of the projection 128 when the valve member 114 is in the open position (FIG. 3), and the opposite side of the main body 140 contacts the valve seat 138 of the retainer 112 when the valve member 114 is in the closed position (FIG. 2). The annular collar 142 of the valve member 114 may be in sliding contact with the inner diametrical surface 121 of the valve housing 110 so that the inner diametrical surface 121 of the valve housing 110 acts as a guide surface as the valve member 114 moves between the open and closed positions. The annular collar 142 may be received in a space radially between the inner diametrical surface 121 and the projection 128 of the valve housing 110 when the valve member 114 is in the open position. In some configurations, the valve member 114 may be entirely disc-shaped and may not include the annular collar 142.

During normal operation of the compressor 10 (e.g., during steady-state operation after startup or during any other operating condition in which working fluid in the fluid pocket at the radially inner position 115 is at a higher pressure than working fluid in the discharge chamber 40), the scrolls 70, 72 may cooperate to compress working fluid (e.g., from the suction pressure to the discharge pressure). Working fluid in the fluid pocket at the radially inner position 115 (e.g., at the discharge pressure) is forced through the discharge passage 90 and through opening 136 in the retainer 112 to force the valve member 114 into the open position (FIG. 3). With the valve member 114 in the open position, the compressed working fluid may flow from the opening 136 through the apertures 124 in the valve housing 110, through the annular gas flow path 122, through the discharge passage 44 of the partition 36, and into the discharge chamber 40. From the discharge chamber 40, the compressed working fluid may flow through the discharge fitting 46 and into the high side of a climate-control system in which the compressor is installed.

When the compressor 10 is shut down or when the compressor 10 is switched to a low-capacity or zero-capacity operating state (or during any other operating condition in which working fluid in the fluid pocket at the radially inner position 115 is at a lower pressure than working fluid in the discharge chamber 40), working fluid from the discharge chamber 40 (or working fluid at the discharge passage 44 of the partition 36) may flow through the gas-return aperture 132 of the valve housing 110 and may force the valve member 114 into the closed position (FIG. 2). As noted above, when the valve member 114 is in the closed position, the apertures 124 in the valve housing 110 are blocked and the opening 136 in the valve retainer 112 is blocked, thereby restricting or preventing fluid flow through the discharge passage 90 (i.e., to reduce or prevent reverse rotation of the orbiting scroll 70).

The shutdown valve assembly 24 described herein has several advantages over prior-art shutdown valves. For example, the structure of the valve housing 110 and valve member 114 provides less surface area over which the valve member 114 and valve housing 110 contact each other. This reduced contact area reduces lateral oil adhesion force between the valve member 114 and the inner diametrical surface 121 of the valve housing 110. Furthermore, the relatively small contact area between the valve member 114 and the valve retainer 112 also reduces adhesion forces between the valve member 114 and the valve retainer 112. Furthermore, the positioning of the apertures 124 along the inner diametrical 121 of the valve housing and the proximity of the apertures 124 relative to the valve seat 138 allow for faster response time of the shutdown valve assembly 24 during shutdown of the compressor 10 (which reduces backflow of working fluid and reduces reverse rotation of the orbiting scroll 70 during shutdown). Furthermore, the structure of the valve housing 110, valve retainer 112, and valve member 114 improves sound performance (i.e., allows for quieter operation). Furthermore, the valve seat 138 being flat (as opposed to tapered) may reduce Poiseuille flow effect.

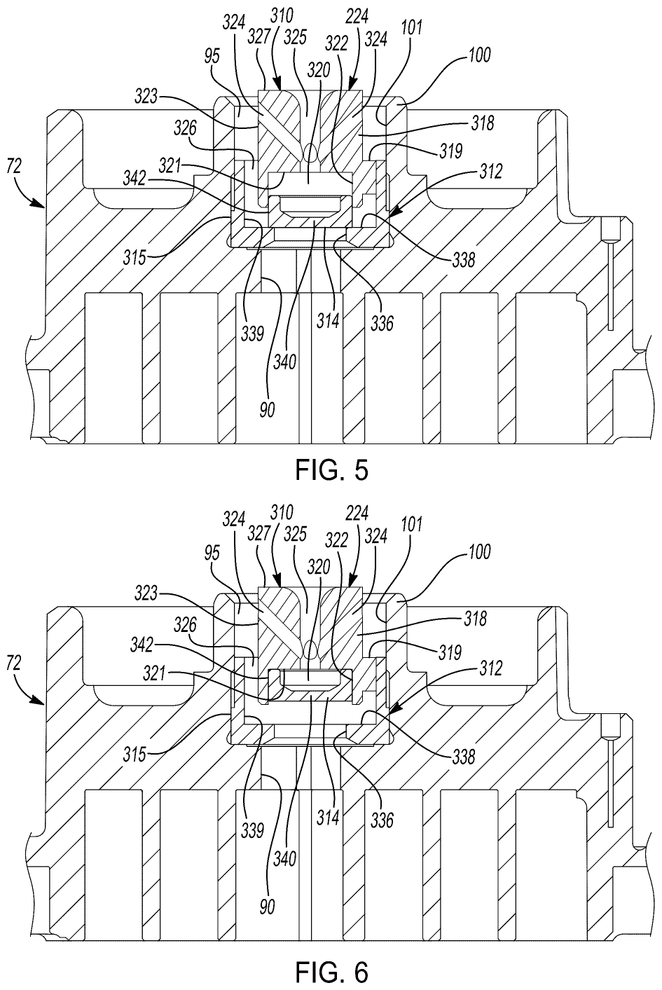

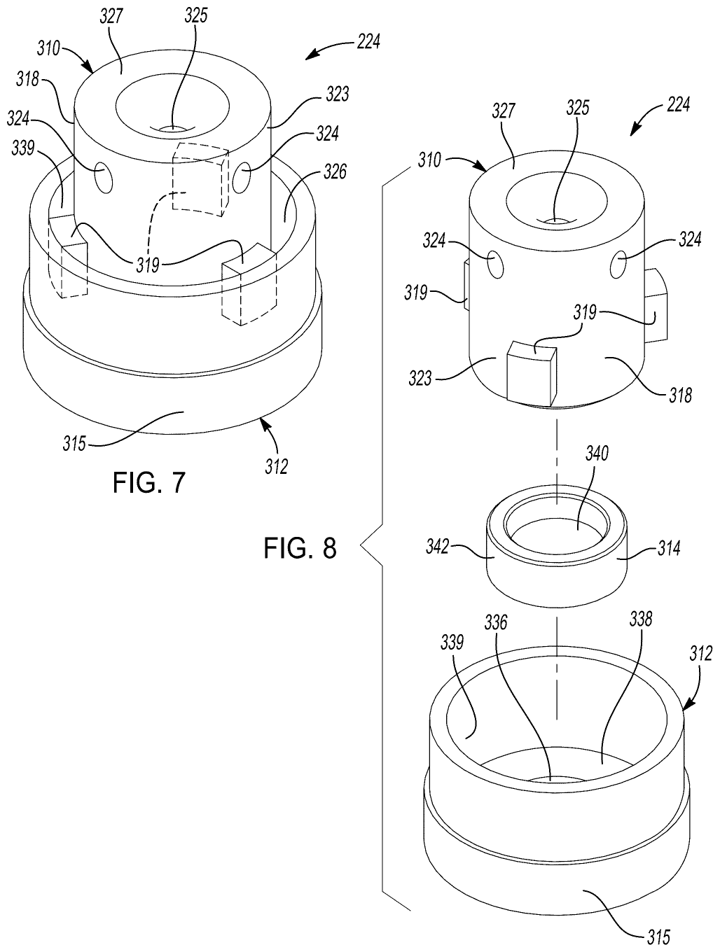

With reference to FIGS. 5-8, another shutdown valve assembly 224 is provided that can be incorporated into the compressor 10 instead of the shutdown valve assembly 24. The shutdown valve assembly 224 is disposed at least partially within the discharge recess 95 of the non-orbiting scroll 72 is operable to selectively allow and prevent fluid flow though the discharge passage 90.

The shutdown valve assembly 224 may include a valve housing 310, a retainer 312, and a valve member 314. The valve member 314 is movable relative to the valve housing 310 and the retainer 312 between a closed position (FIG. 5) and an open position (FIG. 6). When the valve member 314 is in the open position, working fluid is allowed to flow through the shutdown valve assembly 224 between the discharge passage 90 and the discharge chamber 40. When the valve member 314 is in the closed position, working fluid is restricted or prevent from flowing through the shutdown valve assembly 224 thereby restricting or preventing fluid flow between the discharge passage 90 and the discharge chamber 40. Pressure differentials between the discharge passage 90 and the discharge chamber 40 move the valve member 314 between the open and closed positions.

The valve retainer 312 may be a generally cup-shaped body having a radially outer surface 315 that may fixedly engage (e.g., via threaded engagement, press fit, welding, and/or other means) the inner diametrical surface 101 of the hub 100 of the non-orbiting scroll 72. An axial end of the valve retainer 312 may define a valve seat 338 and an opening 336 that extends through the valve seat 338.

The valve housing 310 may include a housing body 318 and a plurality of projections or tabs 319 that extend radially outward from the housing body 318. The housing body 318 may be generally cylindrical and may include a recess 320 (FIGS. 5 and 6) disposed in its lower axial end. The recess 320 reciprocatingly receives the valve member 314 therein. Surface 321 that defines an axial end of the recess 320 acts as a valve stop to limit the upward movement of the valve member 314 and define the fully open position of the valve member 314. A diametrical surface 322 defining the recess 320 may act as a guide surface to guide movement of the valve member 314 between the open and closed positions.

The tabs 319 of the valve housing 310 may fixedly engage (e.g., via threaded engagement, press fit, welding, and/or other means) an inner diametrical surface 339 of the valve retainer 312. The housing body 318 may extend axially upward and out of the valve retainer 312. An outer diametrical surface 323 of the housing body 318 is radially spaced apart from the inner diametrical surface 339 of the valve retainer 312 and the inner diametrical surface 101 of the hub 100. In this manner, the housing body 318, the hub 100, and the valve retainer 312 define an annular gas flow path 326 disposed radially between the inner diametrical surface 101 of the hub 100 and the outer diametrical surface 323 of the housing body 318. Working fluid flows from through the annular gas flow path 326 (i.e., from the discharge passage 90 to the discharge chamber 40) when the valve member 314 is in the open position (FIG. 6). In the closed position (FIG. 5), the valve member 314 blocks fluid from the discharge chamber 40 through from flowing through the annular gas flow path 316 to the discharge passage 90.

The housing body 318 of the valve housing 310 may also include a plurality of apertures 324. The apertures 324 may extend through the outer diametrical surface 323 of the housing body 318 and are in fluid communication with the recess 320. The apertures 324 may be angled (i.e., a longitudinal axis of each aperture 324 may be disposed at a non-parallel and non-perpendicular angle (e.g., a 45-degree angle, for example) relative to the rotational axis of the driveshaft 64). A central aperture 325 may extend axially through axial end 327 of the housing body 318 and may be in fluid communication with the apertures 324 and the recess 320. As shown in FIGS. 5 and 6, the axial end 327 may protrude further upward than the axial end of the hub 100 of the non-orbiting scroll 72.

The valve member 314 shown in the figures is generally cup-shaped and has a U-shaped cross section. The valve member 314 may include a disc-shaped main body 340 and an annular collar 342 extending axially from the main body 340. An axial end of the collar 342 contacts the surface 321 of the valve housing 310 when the valve member 314 is in the open position (FIG. 6), and the opposite axial end of the valve member 314 contacts the valve seat 338 of the retainer 312 when the valve member 314 is in the closed position (FIG. 5). The annular collar 342 of the valve member 314 may be in sliding contact with the inner diametrical surface 322 of the valve housing 310 so that the inner diametrical surface 322 of the valve housing 310 acts as a guide surface as the valve member 314 moves between the open and closed positions. In some configurations, the valve member 314 may be entirely disc-shaped and may not include the annular collar 342.

As described above, during normal operation of the compressor 10, the scrolls 70, 72 compress working fluid (e.g., from the suction pressure to the discharge pressure). Working fluid in the fluid pocket at the radially inner position 115 (e.g., at the discharge pressure) is forced through the discharge passage 90 and through the opening 336 in the retainer 312 to force the valve member 314 into the open position (FIG. 6). With the valve member 314 in the open position, the compressed working fluid may flow from the opening 336 through the annular gas flow path 326, through the discharge passage 44 of the partition 36, and into the discharge chamber 40.

When the compressor 10 is shut down or when the compressor 10 is switched to a low-capacity or zero-capacity operating state (or during any other operating condition in which working fluid in the fluid pocket at the radially inner position 115 is at a lower pressure than working fluid in the discharge chamber 40), working fluid from the discharge chamber 40 (or working fluid at the discharge passage 44 of the partition 36) may flow through the apertures 324, 325 of the valve housing 310 and may force the valve member 314 into the closed position (FIG. 5). As noted above, when the valve member 314 is in the closed position, the annular gas flow path 326 is blocked and the opening 336 in the valve retainer 312 is blocked, thereby restricting or preventing fluid flow through the discharge passage 90 (i.e., to reduce or prevent reverse rotation of the orbiting scroll 70).

The shutdown valve assembly 224 described herein has several advantages over prior-art shutdown valves. For example, the structure of the valve housing 310 and valve member 314 provides less surface area over which the valve member 314 and valve housing 310 contact each other. This reduced contact area reduces lateral oil adhesion force between the valve member 314 and the inner diametrical surface 322 of the valve housing 310. Furthermore, the relatively small contact area between the valve member 314 and the valve retainer 312 also reduces adhesion forces between the valve member 314 and the valve retainer 312. Furthermore, the angled positioning of the apertures 324 in the valve housing 310 (i.e., such that the apertures 324 extend through the outer diametrical surface 323 of the valve housing 310) allows fluid flowing past the opening of the apertures 324 (i.e., fluid flowing up through the annular gas flow path 326) to create a Venturi effect that tends to hold the valve member 314 in the open position and in contact with the surface 321. Furthermore, the shutdown valve assembly 224 achieves faster response time (i.e., faster movement between open and closed position) during shutdown of the compressor 10 (which reduces backflow of working fluid and reduces reverse rotation of the orbiting scroll 70 during shutdown). Furthermore, the structure of the valve housing 310, valve retainer 312, and valve member 314 improves sound performance (i.e., allows for quieter operation). Furthermore, the valve seat 338 being flat (as opposed to tapered) may reduce Poiseuille flow effect.

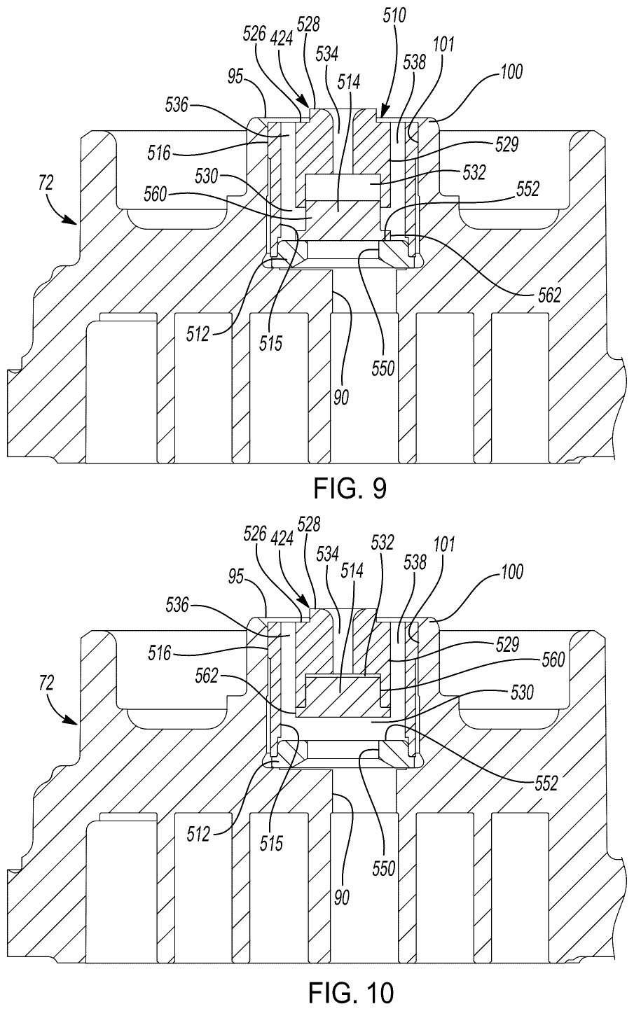

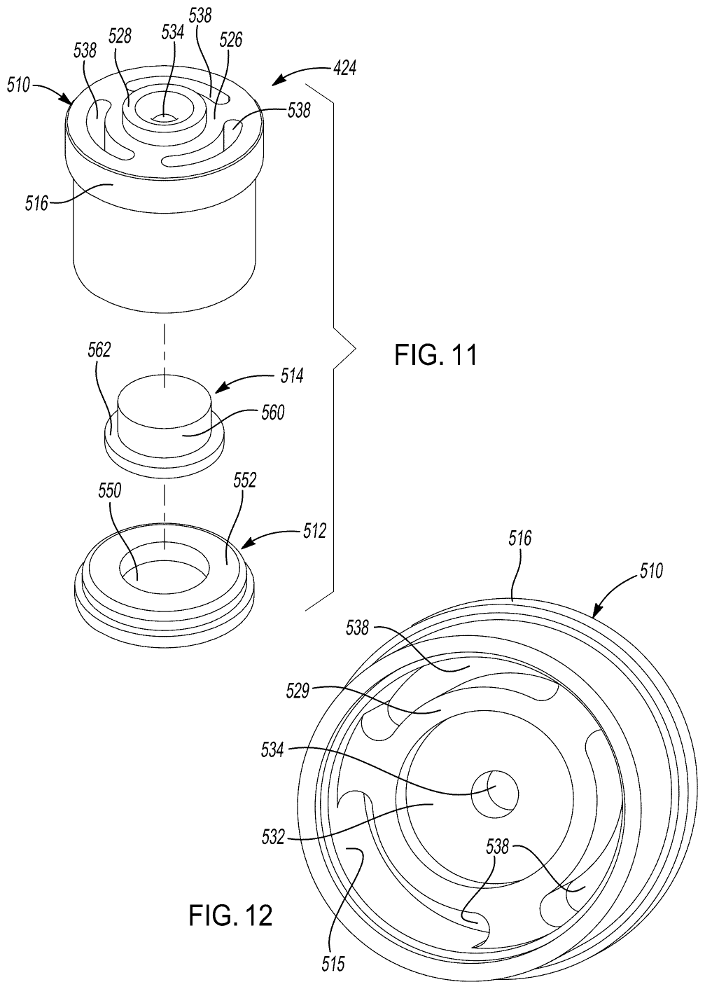

With reference to FIGS. 9-12, another shutdown valve assembly 424 is provided that can be incorporated into the compressor 10 instead of the shutdown valve assembly 24, 224. The shutdown valve assembly 424 is disposed partially within the discharge recess 95 of the non-orbiting scroll 72 is operable to selectively allow and prevent fluid flow though the discharge passage 90.

The shutdown valve assembly 424 may include a valve housing 510, a retainer 512, and a valve member 514. The valve member 514 is movable relative to the valve housing 510 and the retainer 512 between a closed position (FIG. 9) and an open position (FIG. 10). When the valve member 514 is in the open position, working fluid is allowed to flow through the shutdown valve assembly 424 between the discharge passage 90 and the discharge chamber 40. When the valve member 514 is in the closed position, working fluid is restricted or prevent from flowing through the shutdown valve assembly 424 thereby restricting or preventing fluid flow between the discharge passage 90 and the discharge chamber 40. Pressure differentials between the discharge passage 90 and the discharge chamber 40 move the valve member 514 between the open and closed positions.

The valve housing 510 may be a generally cylindrical body having an inner diametrical surface 515 and a radially outermost diametrical surface 516 that is fixedly engaged (e.g., via threaded engagement, press fit, and/or other means) with the inner diametrical surface 101 of the hub 100 of the non-orbiting scroll 72. An axial end face 526 of the valve housing 510 extends radially inward from the diametrical surface 516. The axial end face 526 may include an annular projection 528 that extends from the axial end face 526 in an axial direction toward the discharge chamber 40 (i.e., the annular projection 528 extends axially out of the hub 100 such that the distal axial end of the annular projection 528 is disposed axially above the axial end of the hub 100).

A projection 529 extends from the axial end face 526 in an axial direction (i.e., a direction opposite the direction in which the annular projection 528 extends) into an interior volume 530 of the valve housing 510 (i.e., the interior volume 530 defined by the inner diametrical surface 515). That is, the projection 529 extends from the axial end face 526 toward the discharge passage 90. The projection 529 shown in the figures is cylindrical, but it will be appreciated that the projection 529 could have any other suitable shape such as frustoconical or rectangular prism, for example. The projection 529 may include a recess 532 that reciprocatingly receives the valve member 514. An aperture 534 may extend through the projections 528, 529 and may be in fluid communication with the recess 532. An outer diametrical surface of the projection 529 may be radially spaced apart from the inner diametrical surface 515 of the valve housing 510 such that an annular gas flow path 536 is formed therebetween. Curved apertures 538 formed in the axial end face 526 of the valve housing 510 provide fluid communication between the annular gas flow path 536 and the discharge chamber 40.

The retainer 512 may be fixed relative to the valve housing 510 and may extend into the interior volume 530 of the valve housing 510. The retainer 512 may be an annular member and includes an opening 550 that provides fluid communication between the discharge passage 90 and the interior volume 530 of the valve housing 510. The retainer 512 may define an annular valve seat 552 that contacts the valve member 514 in the closed position (as shown in FIG. 9). When the valve member 514 is in the open position (FIG. 10), the valve member 514 is spaced apart from the valve seat 552 so that fluid can flow from the discharge passage 90 through the opening 550, through the annular gas flow path 536, through the curved apertures 538, and into the discharge chamber 40.

The valve member 514 may include a disc-shaped body 560 and a flange 562 that extends radially outward from the body 560. The body 560 is received in the recess 532 of the valve housing 510 and is in sliding contact with an inner diametrical surface that defines the recess 532. The flange 562 contacts an axial end of the projection 529 when the valve member 514 is in the open position. The flange 562 contacts the valve seat 552 when the valve member 514 is in the closed position.

As described above, during normal operation of the compressor 10, the scrolls 70, 72 compress working fluid (e.g., from the suction pressure to the discharge pressure). Working fluid in the fluid pocket at the radially inner position 115 (e.g., at the discharge pressure) is forced through the discharge passage 90 and through the opening 550 in the retainer 512 to force the valve member 514 into the open position (FIG. 10). With the valve member 514 in the open position, the compressed working fluid may flow from the opening 550 through the annular gas flow path 536, through the curved apertures 538, and into the discharge chamber 40.

When the compressor 10 is shut down or when the compressor 10 is switched to a low-capacity or zero-capacity operating state (or during any other operating condition in which working fluid in the fluid pocket at the radially inner position 115 is at a lower pressure than working fluid in the discharge chamber 40), working fluid from the discharge chamber 40 (or working fluid at the discharge passage 44 of the partition 36) may flow through the aperture 534 of the valve housing 510 and may force the valve member 514 into the closed position (FIG. 9). As noted above, when the valve member 514 is in the closed position, the annular gas flow path 536 is blocked and the opening 550 in the valve retainer 512 is blocked, thereby restricting or preventing fluid flow through the discharge passage 90 (i.e., to reduce or prevent reverse rotation of the orbiting scroll 70).

The shutdown valve assembly 424 described herein has several advantages over prior-art shutdown valves. For example, the structure of the valve housing 510 and valve member 514 provides less surface area over which the valve member 514 and valve housing 510 contact each other. This reduced contact area reduces lateral oil adhesion force between the valve member 514 and the valve housing 310. Furthermore, the relatively small contact area between the valve member 514 and the valve retainer 512 also reduces adhesion forces between the valve member 514 and the valve retainer 512. Furthermore, the shutdown valve assembly 424 achieves faster response time (i.e., faster movement between open and closed position) during shutdown of the compressor 10 (which reduces backflow of working fluid and reduces reverse rotation of the orbiting scroll 70 during shutdown). Furthermore, the annular projection 528 that extends axially above the hub 100 and axially above the curved apertures 538 helps to prevent backflow of fluid through the aperture 534 during normal operating conditions (i.e., conditions in which the valve member 514 is in the open position), which reduces rattling of the valve member 514 and allows for quieter operation.

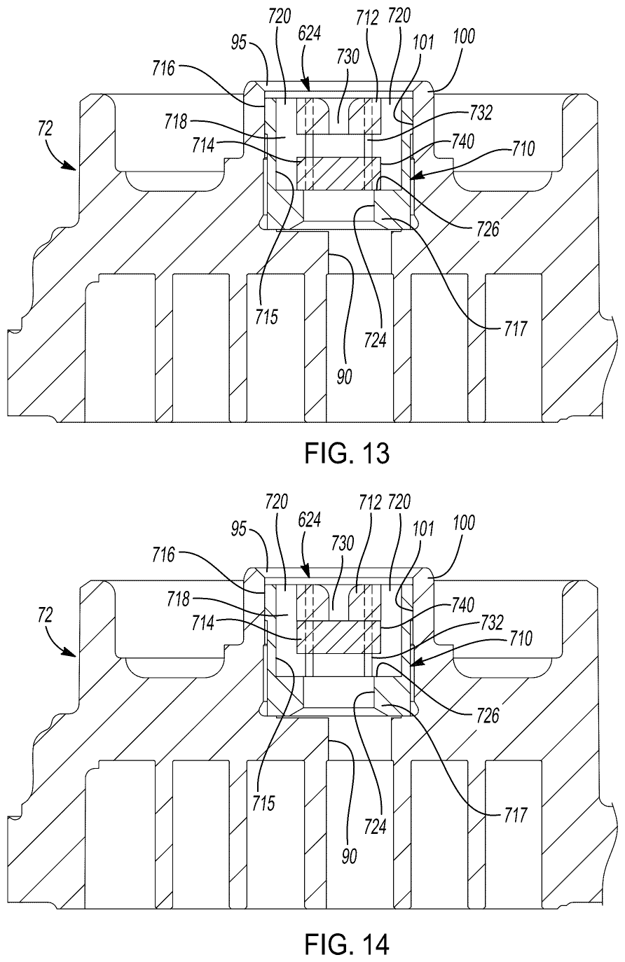

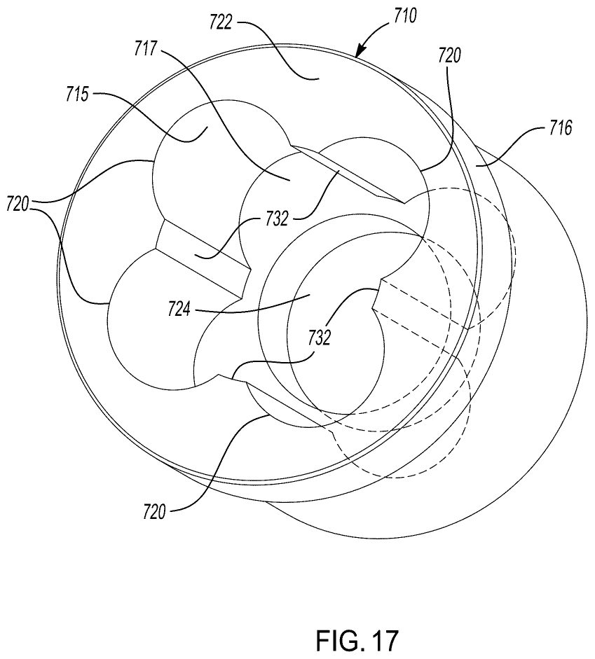

With reference to FIGS. 13-17, another shutdown valve assembly 624 is provided that can be incorporated into the compressor 10 instead of the shutdown valve assembly 24, 224, 424. The shutdown valve assembly 624 is disposed at least partially within the discharge recess 95 of the non-orbiting scroll 72 is operable to selectively allow and prevent fluid flow though the discharge passage 90.

The shutdown valve assembly 624 may include a valve housing 710, a retainer 712, and a valve member 714. The valve member 714 is movable relative to the valve housing 710 and the retainer 712 between a closed position (FIG. 13) and an open position (FIG. 14). When the valve member 714 is in the open position, working fluid is allowed to flow through the shutdown valve assembly 624 between the discharge passage 90 and the discharge chamber 40. When the valve member 714 is in the closed position, working fluid is restricted or prevent from flowing through the shutdown valve assembly 624 thereby restricting or preventing fluid flow between the discharge passage 90 and the discharge chamber 40. Pressure differentials between the discharge passage 90 and the discharge chamber 40 move the valve member 714 between the open and closed positions.

The valve housing 710 may be a generally cylindrical body having an inner surface 715, a radially outermost diametrical surface 716, and an annular ledge 717. The radially outermost diametrical surface 716 is fixedly engaged (e.g., via threaded engagement, press fit, and/or other means) with the inner diametrical surface 101 of the hub 100 of the non-orbiting scroll 72. The inner surface 715 defines an interior volume 718 of the valve housing 710. The inner surface 715 defines a plurality of scallop-shaped apertures 720 that extend through an axial end face 722 of the valve housing 710. The ledge 717 includes an opening 724 and defines a valve seat 726. The opening 724 is in fluid communication with the discharge passage 90. The valve seat 726 contacts the valve member 714 in the closed position to prevent fluid flow through the opening 724 and discharge passage 90.

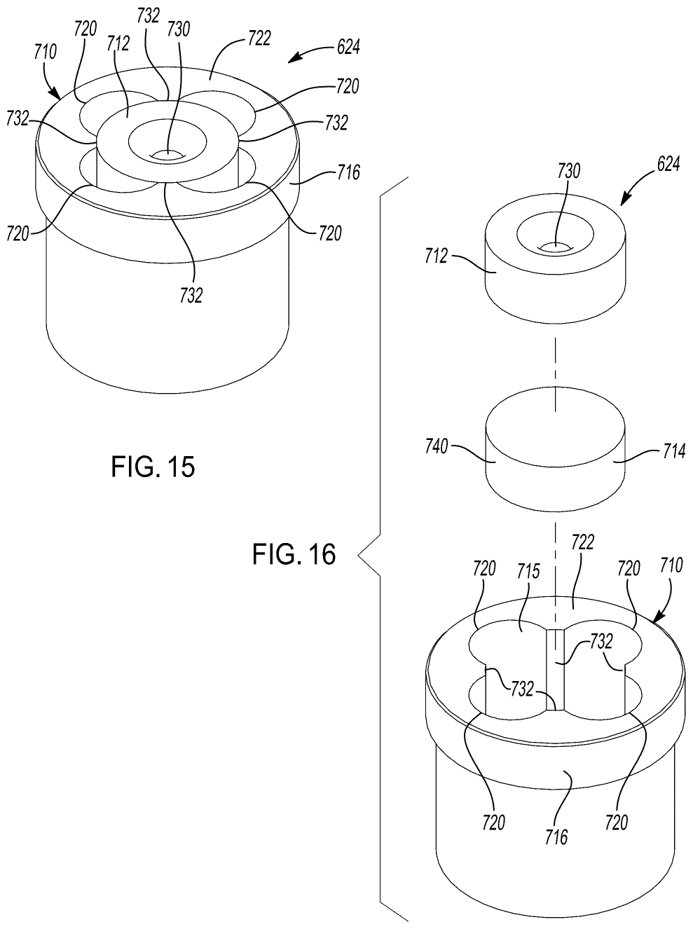

The valve retainer 712 may be a disc-shaped body having a central aperture 730. An outer diametrical surface of the valve retainer 712 may fixedly engage (e.g., via threaded engagement, press-fit, welding, and/or other means) a plurality of guide surfaces 732 of the inner surface 715, as shown in FIG. 15. The valve retainer 712 acts as a valve stop that defines the fully open position of the valve member 714 (i.e., the valve member 714 contacts the valve retainer 712 in the open position).

The valve member 714 may be a disc-shaped body. An outer diametrical surface 740 of the valve member 714 may slidingly contact the guide surfaces 732 of the valve housing 710.

As described above, during normal operation of the compressor 10, the scrolls 70, 72 compress working fluid (e.g., from the suction pressure to the discharge pressure). Working fluid in the fluid pocket at the radially inner position 115 (e.g., at the discharge pressure) is forced through the discharge passage 90 and through the opening 724 in the valve housing 710 to force the valve member 714 into the open position (FIG. 14). With the valve member 714 in the open position, the compressed working fluid may flow from the opening 724 through the interior volume 718, through the apertures 720, and into the discharge chamber 40.

When the compressor 10 is shut down or when the compressor 10 is switched to a low-capacity or zero-capacity operating state (or during any other operating condition in which working fluid in the fluid pocket at the radially inner position 115 is at a lower pressure than working fluid in the discharge chamber 40), working fluid from the discharge chamber 40 (or working fluid at the discharge passage 44 of the partition 36) may flow through the aperture 730 of the valve retainer 712 and may force the valve member 714 into the closed position (FIG. 13). As noted above, when the valve member 714 is in the closed position, the opening 724 in the valve housing 710 is blocked, thereby restricting or preventing fluid flow through the discharge passage 90 (i.e., to reduce or prevent reverse rotation of the orbiting scroll 70).

The shutdown valve assembly 624 described herein has several advantages over prior-art shutdown valves. For example, the structure of the valve housing 710 and valve member 714 provides less surface area over which the valve member 714 and valve housing 710 contact each other. This reduced contact area reduces lateral oil adhesion force between the valve member 714 and the guide surfaces 732 of the valve housing 710. Furthermore, the relatively small contact area between the valve member 714 and the valve seat 726 also reduces adhesion forces between the valve member 714 and the valve housing 710. Furthermore, the shutdown valve assembly 624 achieves faster response time (i.e., faster movement between open and closed position) during shutdown of the compressor 10 (which reduces backflow of working fluid and reduces reverse rotation of the orbiting scroll 70 during shutdown).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A compressor comprising:
a first scroll having a first end plate and a first spiral wrap extending from the first end plate;
a second scroll having a second end plate and a second spiral wrap extending from the second end plate and meshing with the first spiral wrap to define fluid pockets therebetween, wherein the second end plate includes a discharge passage and a discharge recess; and
a valve assembly disposed at least partially within the discharge recess and including a valve housing fixed relative to the second scroll, a valve retainer fixed relative to the valve housing, and a valve member movably received in the valve housing,
wherein:
the valve member is movable relative to the valve housing and valve retainer between an open position and a closed position,
when the valve member is in the open position, fluid is allowed to flow through the discharge passage and the valve assembly,
when the valve member is in the closed position, fluid flow through the discharge passage and the valve assembly is restricted, and
the valve housing includes a plurality of angled apertures that are angled relative to a direction in which the valve member moves between the open and closed positions.

2. The compressor of claim 1, wherein the angled apertures in the valve housing extend between an inner diametrical surface of the valve housing and an outer diametrical surface of the valve housing.

3. The compressor of claim 2, wherein the openings of the angled apertures at the inner diametrical surface of the valve housing are disposed between the valve member and the discharge passage when the valve member is in the open position.

4. The compressor of claim 3, wherein a radially outer surface of the valve member covers the openings of the angled apertures when the valve member is in the closed position.

5. The compressor of claim 4, wherein the radially outer surface of the valve member slidingly contacts the inner diametrical surface of the valve housing as the valve member moves between the open and closed positions.

6. The compressor of claim 3, wherein the valve housing includes a gas-return aperture, and wherein the gas-return aperture and the angled apertures are in fluid communication with a discharge-pressure region of the compressor.

7. The compressor of claim 6, wherein the valve housing includes a projection that extends into an interior volume of the valve housing and includes an axial end surface that defines a stop for the valve member in the open position.

8. The compressor of claim 7, wherein the gas-return aperture extends through the axial end surface of the projection.

9. The compressor of claim 1, wherein the valve retainer defines a valve seat that contacts the valve member when the valve member is in the closed position, and wherein the valve seat defines an opening that is in fluid communication with the discharge passage.

10. The compressor of claim 1, wherein:
the valve housing includes a base portion and a body portion,
the base portion has a larger diameter than the body portion and fixedly engages an inner diametrical surface of a hub of the second scroll,
the angled apertures are disposed in the body portion, and
the body portion and the inner diametrical surface of the hub cooperate to define an annular gas flow path that is in fluid communication with the angled apertures and the discharge passage when the valve member is in the open position.

11. A compressor comprising:
a first scroll having a first end plate and a first spiral wrap extending from the first end plate;
a second scroll having a second end plate and a second spiral wrap extending from the second end plate and meshing with the first spiral wrap to define fluid pockets therebetween, wherein the second end plate includes a discharge passage; and
a valve assembly including a valve housing fixed relative to the second scroll, a valve retainer fixed relative to the valve housing, and a valve member movably received in the valve housing,
wherein:
the valve housing includes a plurality of angled apertures that are angled relative to a direction in which the valve member moves between the open and closed positions,
the valve member is movable relative to the valve housing and valve retainer between an open position and a closed position,
when the valve member is in the open position, fluid is allowed to flow through the discharge passage and through the angled apertures in the valve housing, and
when the valve member is in the closed position, fluid flow through the discharge passage and the angled apertures is restricted.

12. The compressor of claim 11, wherein the angled apertures in the valve housing extend between an inner diametrical surface of the valve housing and an outer diametrical surface of the valve housing.

13. The compressor of claim 12, wherein the openings of the angled apertures at the inner diametrical surface of the valve housing are disposed between the valve member and the discharge passage when the valve member is in the open position.

14. The compressor of claim 13, wherein a radially outer surface of the valve member covers the openings of the angled apertures when the valve member is in the closed position.

15. The compressor of claim 14, wherein the radially outer surface of the valve member slidingly contacts the inner diametrical surface of the valve housing as the valve member moves between the open and closed positions.

16. The compressor of claim 13, wherein the valve housing includes a gas-return aperture, and wherein the gas-return aperture and the angled apertures are in fluid communication with a discharge-pressure region of the compressor.

17. The compressor of claim 16, wherein the valve housing includes a projection that extends into an interior volume of the valve housing and includes an axial end surface that defines a stop for the valve member in the open position.

18. The compressor of claim 17, wherein the gas-return aperture extends through the axial end surface of the projection.

19. The compressor of claim 11, wherein the valve retainer defines a valve seat that contacts the valve member when the valve member is in the closed position, and wherein the valve seat defines an opening that is in fluid communication with the discharge passage.

20. The compressor of claim 11, wherein:
the valve housing includes a base portion and a body portion,
the base portion has a larger diameter than the body portion and fixedly engages an inner diametrical surface of a hub of the second scroll,
the angled apertures are disposed in the body portion, and
the body portion and the inner diametrical surface of the hub cooperate to define an annular gas flow path that is in fluid communication with the angled apertures and the discharge passage when the valve member is in the open position.
